(19) United States
(12) Patent Application Publication
(10) Pub. No.: US 2026/0134734 A1
(43) Pub. Date: May 14, 2026

(54) SHEET RECOGNITION UNIT AND SHEET RECOGNITION METHOD

(71) Applicant: Glory Ltd., Himeji-shi (JP)

(72) Inventors: Takeshi SATO, Himeji-shi (JP); Akira BOGAKI, Himeji-shi (JP); Fumiaki SHIMAOKA, Himeji-shi (JP); Takaaki MORIMOTO, Himeji-shi (JP)

(73) Assignee: Glory Ltd., Himeji-shi (JP)

(21) Appl. No.: 19/377,092

(22) Filed: Nov. 3, 2025

(30) Foreign Application Priority Data
Nov. 8, 2024 (JP) 2024-196080

(51) Int. Cl. G07D 7/1205; G07D 7/121

(52) U.S. Cl. CPC G07D 7/1205; G07D 7/121; G07D 2207/00

(57) ABSTRACT

Provided is a sheet recognition unit including: a light source capable of emitting light having a specific wavelength to a sheet to be recognized, a light sensor that receives light coming from the sheet to be recognized, based on the light from the light source and outputs a light detection signal, and processing circuitry that recognizes the sheet to be recognized, using the light detection signal output from the light receiving unit. The light sensor includes a first light receiving element including a color filter that transmits blue light and infrared light, a second light receiving element including a color filter that transmits green light and infrared light, a third light receiving element including a color filter that transmits red light and infrared light, and a fourth light receiving element including a color filter that transmits only one of blue light, green light, red light, or infrared light.

### CROSS-REFERENCE TO RELATED APPLICATION

The present application claims priority to Japanese Patent Application No. 2024-196080 filed on Nov. 8, 2024 under the Paris Convention and provisions of national law in a designated State. The entire contents of the application are hereby incorporated by reference.

### TECHNICAL FIELD

The present disclosure relates to a sheet recognition unit and a sheet recognition method.

### BACKGROUND

Conventionally, a photoluminescent compound is known as a security element attached to a sheet such as a banknote. The photoluminescent compound is excited by ultraviolet light to generate fluorescence emission or phosphorescence emission.

### SUMMARY

A sheet recognition unit of the present disclosure includes a light source capable of emitting light having a specific wavelength to a sheet to be recognized, a light sensor that receives light coming from the sheet to be recognized, based on the light from the light source and outputs a light detection signal, and processing circuitry that recognizes the sheet to be recognized, using the light detection signal output from the light sensor. The light sensor includes a first light receiving element including a color filter that transmits blue light and infrared light, a second light receiving element including a color filter that transmits green light and infrared light, a third light receiving element including a color filter that transmits red light and infrared light, and a fourth light receiving element including a color filter that transmits only one of blue light, green light, red light, or infrared light.

### BRIEF DESCRIPTION OF DRAWINGS

FIG. 1 is a schematic diagram illustrating an example of a configuration of a sheet recognition unit according to a first embodiment, and is a diagram viewed from an oblique direction;

FIG. 2 is a schematic plan view describing an example of a configuration of a light receiving unit included in the sheet recognition unit according to the first embodiment;

FIG. 3 is a graph illustrating an example of wavelength characteristics of color filters of the light receiving unit illustrated in FIG. 2;

FIG. 4 is a schematic plan view describing another example of the configuration of the light receiving unit included in the sheet recognition unit according to the first embodiment;

FIG. 5 is a graph illustrating an example of wavelength characteristics of the color filters of the light receiving unit illustrated in FIG. 4;

FIG. 6 is a schematic diagram describing an example of subtraction processing executed by a recognition unit using output values of the light receiving unit illustrated in FIG. 2;

FIG. 7 is a schematic diagram describing an example of the subtraction processing executed by the recognition unit using output values of the light receiving unit illustrated in FIG. 4;

FIG. 8 is a schematic plan view describing still another example of the configuration of the light receiving unit included in the sheet recognition unit according to the first embodiment;

FIG. 9 is a schematic plan view describing still another example of the configuration of the light receiving unit included in the sheet recognition unit according to the first embodiment;

FIG. 10 is a schematic plan view describing still another example of the configuration of the light receiving unit included in the sheet recognition unit according to the first embodiment;

FIG. 11 is a flowchart describing an example of an operation of the sheet recognition unit according to the first embodiment;

FIG. 12 is a plan view schematically illustrating an example of a genuine banknote, and illustrating a state of visible light emission;

FIG. 13 is a plan view schematically illustrating an example of a genuine banknote, and illustrating a state of ultraviolet light emission;

FIG. 14 is a flowchart describing an example of an operation of a sheet recognition unit according to a second embodiment;

FIG. 15 is a schematic perspective view illustrating an appearance of an example of a sheet handling device according to a third embodiment;

FIG. 16 is a schematic cross-sectional view describing an example of a configuration of an imaging unit included in a sheet recognition unit according to the third embodiment; and

FIG. 17 is a block diagram describing an example of a configuration of the sheet recognition unit according to the third embodiment.

### DETAILED DESCRIPTION

An object of the present disclosure is to provide a sheet recognition unit, a sheet handling device, a sheet recognition method, and a non-transitory computer-readable storage medium capable of simultaneously acquiring visible range data and infrared range data without using a filter configuration that is difficult to manufacture.

In order to solve the above-described problems and achieve the object, (1) a sheet recognition unit from a first aspect of the present disclosure includes a light source capable of emitting light having a specific wavelength to a sheet to be recognized, a light sensor that receives light coming from the sheet to be recognized, based on the light from the light source and outputs a light detection signal, and processing circuitry that recognizes the sheet to be recognized, using the light detection signal output from the light sensor. The light sensor includes a first light receiving element including a color filter that transmits blue light and infrared light, a second light receiving element including a color filter that transmits green light and infrared light, a third light receiving element including a color filter that transmits red light and infrared light, and a fourth light receiving element including a color filter that transmits only one of blue light, green light, red light, or infrared light.
(2) In the sheet recognition unit described in (1), the processing circuitry may subtract an output value of the fourth light receiving element from at least one of an output value of the first light receiving element, an output value of the second light receiving element, or an output value of the third light receiving element, and recognize the sheet to be recognized, using a subtraction result.
(3) In the sheet recognition unit described in (2), the color filter of the fourth light receiving element may transmit only infrared light, and the processing circuitry may subtract the output value of the fourth light receiving element from at least one of the output value of the first light receiving element, the output value of the second light receiving element, or the output value of the third light receiving element to calculate at least one of an amount of blue light, an amount of green light, or an amount of the red light as the subtraction result.
(4) In the sheet recognition unit described in (2), the color filter of the fourth light receiving element may transmit only blue light, and the processing circuitry may subtract the output value of the fourth light receiving element from the output value of the first light receiving element to calculate an amount of infrared light as the subtraction result.
(5) In the sheet recognition unit described in (4), the processing circuitry may subtract the amount of the infrared light from at least one of the output value of the second light receiving element or the output value of the third light receiving element to further calculate at least one of an amount of green light or an amount of red light as the subtraction result.
(6) In the sheet recognition unit described in (2), the color filter of the fourth light receiving element may transmit only green light, and the processing circuitry may subtract the output value of the fourth light receiving element from the output value of the second light receiving element to calculate an amount of infrared light as the subtraction result.
(7) In the sheet recognition unit described in (6), the processing circuitry may subtract the amount of the infrared light from at least one of the output value of the first light receiving element or the output value of the third light receiving element to further calculate at least one of an amount of blue light or an amount of red light as the subtraction result.
(8) In the sheet recognition unit described in (2), the color filter of the fourth light receiving element may transmit only red light, and the processing circuitry may subtract the output value of the fourth light receiving element from the output value of the third light receiving element to calculate an amount of infrared light as the subtraction result.
(9) In the sheet recognition unit described in (8), the processing circuitry may subtract the amount of the infrared light from at least one of the output value of the first light receiving element or the output value of the second light receiving element to further calculate at least one of an amount of blue light or an amount of green light as the subtraction result.
(10) In the sheet recognition unit described in any one of (1) to (9), the first light receiving element, the second light receiving element, the third light receiving element, and the fourth light receiving element may be arranged in a row in a main scanning direction.
(11) In the sheet recognition unit described in any one of (1) to (9), the first light receiving element, the second light receiving element, and the third light receiving element may be arranged in a row along a first reference line parallel to a main-scanning direction, and the fourth light receiving elements may be arranged in a row along a second reference line parallel to the main-scanning direction, the second reference line being at a position shifted from the first reference line to a sub-scanning direction.
(12) In the sheet recognition unit described in any one of (1) to (11), the light having specific wavelength emitted by the light source may be ultraviolet light, the light sensor may receive photoluminescence emitted from the sheet to be recognized, the sheet being irradiated with the ultraviolet light, and output a photoluminescence detection signal as the light detection signal, and the processing circuitry may recognize the sheet to be recognized, using the photoluminescence detection signal output from the light sensor.
(13) In the sheet recognition unit described in (12), the processing circuitry may recognize the sheet to be recognized, based on whether a visible photoluminescence emission amount and an infrared photoluminescence emission amount of the sheet to be recognized are within an allowable range with respect to reference data relating to a visible photoluminescence emission amount and an infrared photoluminescence emission amount in a genuine sheet.
(14) In the sheet recognition unit described in (13), the reference data may include a ratio between the visible photoluminescence emission amount and the infrared photoluminescence emission amount, and the processing circuitry may calculate the ratio between the visible photoluminescence emission amount and the infrared photoluminescence emission amount of the sheet to be recognized, and may recognize the sheet to be recognized, based on whether the ratio is within an allowable range with respect to the ratio included in the reference data.
(15) In the sheet recognition unit described in (13) or (14), the light sensor may receive photoluminescence of at least one color among blue, green, or red as the visible photoluminescence and output a photoluminescence detection signal of the at least one color, the reference data may relate to a photoluminescence emission amount of the at least one color and an infrared photoluminescence emission amount, and the processing circuitry may recognize the sheet to be recognized, based on whether the photoluminescence emission amount of the at least one color and the infrared photoluminescence emission amount of the sheet to be recognized are within an allowable range with respect to the reference data.
(16) In the sheet recognition unit described in (15), the light sensor may receive green photoluminescence as the visible photoluminescence and output a green photoluminescence detection signal, the reference data may relate to a green photoluminescence emission amount and an infrared photoluminescence emission amount, and the processing circuitry may recognize the sheet to be recognized, based on whether the green photoluminescence emission amount and the infrared photoluminescence emission amount of the sheet to be recognized are within an allowable range with respect to the reference data.
(17) In the sheet recognition unit described in (15), the light sensor may receive red photoluminescence as the visible photoluminescence and output a red photoluminescence detection signal, the reference data may relate to a red photoluminescence emission amount and an infrared photoluminescence emission amount, and the processing circuitry may recognize the sheet to be recognized, based on whether the red photoluminescence emission amount and the infrared photoluminescence emission amount of the sheet to be recognized are within an allowable range with respect to the reference data.
(18) In the sheet recognition unit described in (15), the light sensor may receive blue photoluminescence as the visible photoluminescence and output a photoluminescence detection signal, the reference data may relate to a blue photoluminescence emission amount and an infrared photoluminescence emission amount, and the processing circuitry may recognize the sheet to be recognized, based on whether the blue photoluminescence emission amount and the infrared photoluminescence emission amount of the sheet to be recognized are within an allowable range with respect to the reference data.
(19) In the sheet recognition unit described in any one of (13) to (18), the light sensor may receive near-infrared photoluminescence as the infrared photoluminescence and output a near-infrared photoluminescence detection signal, the reference data may relate to a visible photoluminescence emission amount and a near-infrared photoluminescence emission amount, and the processing circuitry may recognize the sheet to be recognized, based on whether the visible photoluminescence emission amount and the near-infrared photoluminescence emission amount of the sheet to be recognized are within an allowable range with respect to the reference data.
(20) Further, a sheet handling device from a second aspect of the present disclosure includes the sheet recognition unit in any one of (1) to (19).
(21) A sheet recognition method from a third aspect of the present disclosure includes emitting light having a specific wavelength to a sheet to be recognized from a light source, receiving, with a light sensor, light coming from the sheet to be recognized, based on the light from the light source and outputting a light detection signal, and recognizing the sheet to be recognized, using the light detection signal output from the light sensor. The light sensor includes a first light receiving element including a color filter that transmits blue light and infrared light, a second light receiving element including a color filter that transmits green light and infrared light, a third light receiving element including a color filter that transmits red light and infrared light, and a fourth light receiving element including a color filter that transmits only one of blue light, green light, red light, or infrared light.
(22) A non-transitory computer-readable storage medium from a fourth aspect of the present disclosure stores a sheet recognition program that causes a sheet recognition unit to execute processing including emitting light having a specific wavelength to a sheet to be recognized from a light source, receiving, with a light sensor, light coming from the sheet to be recognized, based on the light from the light source and outputting a light detection signal, and recognizing the sheet to be recognized, using the light detection signal output from the light sensor. The light sensor includes a first light receiving element including a color filter that transmits blue light and infrared light, a second light receiving element including a color filter that transmits green light and infrared light, a third light receiving element including a color filter that transmits red light and infrared light, and a fourth light receiving element including a color filter that transmits only one of blue light, green light, red light, or infrared light.

The present disclosure can provide a sheet recognition unit, a sheet handling device, a sheet recognition method, and a non-transitory computer-readable storage medium capable of simultaneously acquiring visible range data and infrared range data without using a filter configuration that is difficult to manufacture.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality.

Processors are considered processing circuitry or circuitry as they include transistors and other circuitry therein. The processor may be a programmed processor which executes a program stored in a memory.

In the disclosure, the circuitry, units, or means are hardware that carry out or are programmed to perform the recited functionality. The hardware may be any hardware disclosed herein or otherwise known which is programmed or configured to carry out the recited functionality.

When the hardware is a processor which may be considered a type of circuitry, the circuitry, means, or units are a combination of hardware and software, the software being used to configure the hardware and/or processor.

Hereinafter, embodiments of a sheet recognition unit, a sheet handling device, a sheet recognition method, and a non-transitory computer-readable storage medium of the present disclosure will be described in detail with reference to the drawings. Various sheets applicable as target sheets of the present disclosure include banknotes, checks, vouchers, bills, forms, securities, and card-like media, but hereinafter, the present disclosure will be described using devices for banknotes as an example.

Note that the sheet recognition program may be introduced in advance into the sheet recognition unit and the sheet handling device, or may be provided to an operator with the program being recorded in a computer-readable recording medium or provided via a network.

As described above, the sheet recognition unit and the sheet handling device of the present disclosure may include a storage unit (memory) including a storage device such as a semiconductor memory (random-access memory [RAM] or read-only memory [ROM]) and a hard disk.

In the following description, the same reference signs are appropriately used for the same portions or portions having similar functions between different drawings, and repeated description thereof is appropriately omitted. Further, in the drawings illustrating a structure, XYZ coordinate systems orthogonal to each other are appropriately illustrated.

### First Embodiment

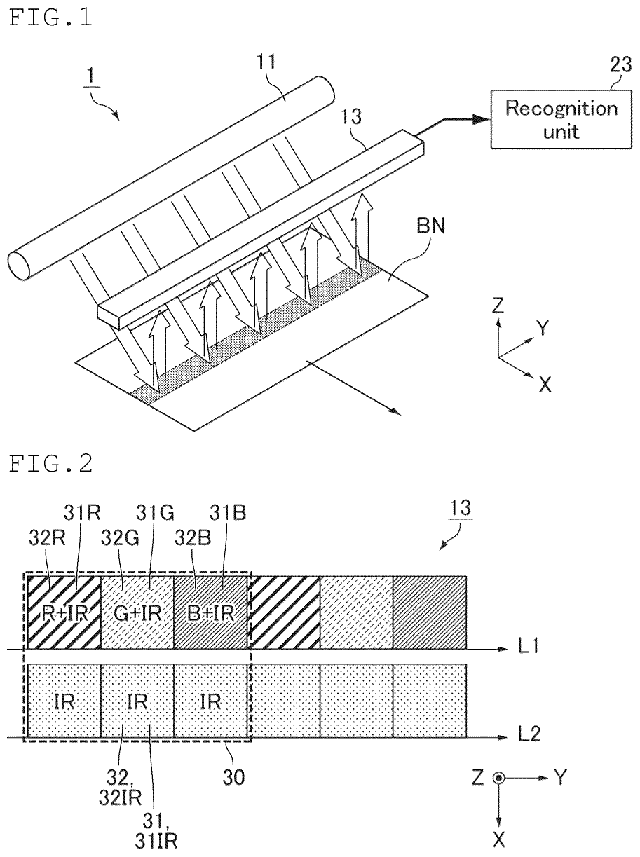

A configuration of the sheet recognition unit according to the present embodiment will be described with reference to FIG. 1.

As illustrated in FIG. 1, the sheet recognition unit 1 according to the present embodiment detects light coming from a banknote BN to be recognized. The sheet recognition unit 1 includes a light source 11, a light receiving unit (light sensor) 13, and a recognition unit 23. The light source 11 is capable of emitting light with a specific wavelength to the banknote BN to be transported. The light receiving unit 13 receives light coming from the banknote BN based on the light from the light source 11, and outputs a light detection signal. The recognition unit 23 recognizes the banknote BN to be recognized, using the light detection signal output from the light receiving unit 13.

Here, the banknote BN to be recognized may be transported in an X direction in an XY plane. A Y direction may correspond to a main scanning direction of the light receiving unit 13, and the X direction may correspond to a sub-scanning direction of the light receiving unit 13.

The light source 11 may be longer than the length of the banknote BN in the Y direction, and may irradiate the banknote BN entirely in the Y direction with light linearly extending along the Y direction. In this case, the light source 11 may include a linear rod-shaped transparent light guide, and light emitting elements (usually, a plurality of light emitting diodes (LEDs), for example) facing at least one of both end surfaces of the light guide. The light source 11 may irradiate the banknote BN with light via the light guide.

The light receiving unit 13 is configured to be able to receive light coming from the banknote BN based on the light from the light source 11. For example, the light receiving unit 13 may be configured to be able to receive fluorescence emitted from the banknote BN while light with a specific wavelength is being emitted. That is, the light receiving unit 13 may be configured to be able to detect fluorescence from the banknote BN. The light receiving unit 13 may be configured to be able to receive reflective light or transmissive light reflected or transmitted by the banknote BN while light with a specific wavelength is being emitted, or may be configured to be able to receive phosphorescence emitted from the banknote BN after light with a specific wavelength is emitted. At this time, the light receiving unit 13 can function as a sensor having sensitivity to at least one of a wavelength band of fluorescence emitted from a fluorescent ink, a wavelength band of reflective light or transmissive light of the light with specific wavelength, or a wavelength band of phosphorescence emitted from the fluorescent ink. The light receiving unit 13 can then function as a sensor that outputs an electric signal (which may be a digital signal) corresponding to the amount of incident light (light receiving amount). That is, the light detection signal is an electric signal that depends on an amount of incident light coming from the banknote BN.

The light receiving unit 13 includes first to fourth light receiving elements, described later, and the light receiving elements may receive light, convert the light into an electric signal that depends on an incident light amount, and output the electric signal.

The light receiving unit 13 may be longer than the length of the banknote BN in the Y direction, and may receive light transmitted through, reflected from, or emitted from the banknote BN entirely in the Y direction.

The light receiving unit 13 may output an electric signal depending on the amount of incident light as image data. At this time, the light receiving unit 13 may include a plurality of pixels arranged in a row in the Y direction (main scanning direction). That is, the light receiving unit 13 may output an electric signal depending on the amount of incident light at a plurality of channels corresponding to the plurality of pixels (positions in the Y direction (main scanning direction)). Note that the channels (columns) are numbers sequentially allocated to the light receiving elements (imaging elements) in the Y direction. At this time, the light receiving unit 13 may output, as image data, line data that is data related to the light simultaneously received at each channel. The image data of the entire banknote BN may be output by repeating irradiation with light from the light source 11 and reception of light by the light receiving unit 13 while transporting the banknote BN in the X direction (sub-scanning direction).

As described above, the light source 11 and the light receiving unit 13 may acquire the image of the entire banknote BN by continuously and repeatedly executing imaging of a predetermined cycle as one period.

In this specification, one cycle refers to a control pattern in which the timing of turning on and off the light emitting elements in each wavelength band, signal reading, and the like are set. The light detection signal may be acquired from an entire sheet by continuously and repeatedly executing the control pattern of one cycle as one period. One cycle may indicate a periodic control pattern related to turning-on, turning-off, and light reception, the control pattern being set to acquire a reflective light image and/or transmissive light image of the sheet.

The reflective light image is an image based on light emitted from a light source disposed on the same side as the light receiving unit with respect to the sheet and reflected from the sheet. The transmissive light image is an image based on light emitted from a light source disposed on an opposite side from the light receiving unit with respect to the sheet and transmitted through the sheet. Therefore, the reflective light image and the transmissive light image are distinguished from a fluorescent image or a phosphorescent image based on fluorescence or phosphorescence emitted from the sheet.

The image data that can be acquired by the light receiving unit 13 includes a plurality of pixels arranged in a matrix pattern in the Y direction (main scanning direction) and the X direction (sub-scanning direction). An address of each pixel is specified by a channel (column) of the light receiving unit 13 corresponding to the position in the Y direction and a line (row) corresponding to the position in the X direction. The line (row) is a number sequentially allocated to the line data sequentially output from the light receiving unit 13.

The light receiving unit 13 may receive light with a plurality of wavelength bands coming from the banknote BN and output an electric signal (light detection signal) for the plurality of wavelength bands. In this case, each pixel may include a plurality of light receiving elements that selectively receive light in different wavelength bands.

Examples of the plurality of wavelength bands in which the light receiving unit 13 can selectively receive light include red (R), green (G), blue (B), and infrared (IR) bands.

In this specification, blue means light (color) having a wavelength of approximately 400 to 500 nm, and may be light (color) having a peak wavelength in this wavelength band. Green means light (color) having a wavelength of approximately 500 to 600 nm, and may be light (color) having a peak wavelength in this wavelength band. Red means light (color) having a wavelength of approximately 600 to 750 nm, and may be light (color) having a peak wavelength in this wavelength band. The infrared light means light having a wavelength of approximately 750 nm or more, and may be light having a peak wavelength in this wavelength band. The near-infrared light means light having a wavelength of approximately 750 to 1500 nm, and may be light having a peak wavelength in this wavelength band.

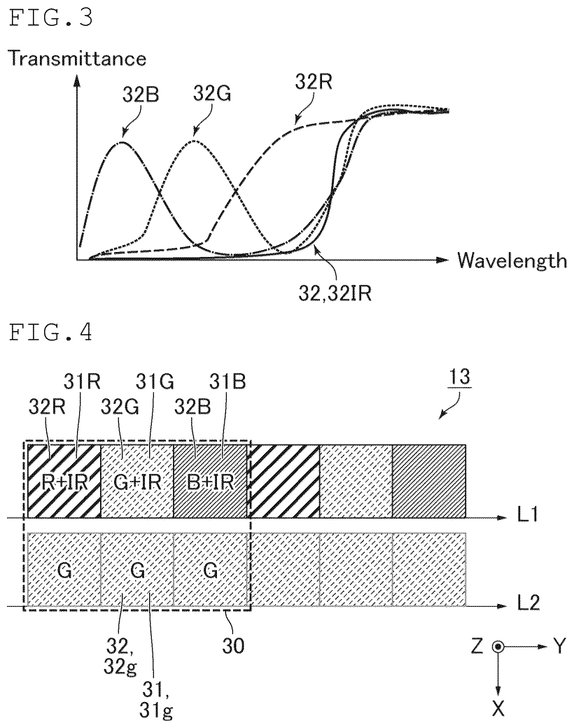

In the present embodiment, as illustrated in FIGS. 2 and 3, the light receiving unit 13 includes a first light receiving element 31B including a color filter 32B that transmits blue light and infrared light, a second light receiving element 31G including a color filter 32G that transmits green light and infrared light, a third light receiving element 31R including a color filter 32R that transmits red light and infrared light, and a fourth light receiving element 31 including a color filter 32 that transmits only one of blue light, green light, red light, or infrared light. Therefore, the first light receiving element 31B, the second light receiving element 31G, and the third light receiving element 31R receive infrared light together with the corresponding visible light. On the other hand, the fourth light receiving element 31 receives only any one of blue light, green light, red light, or infrared light. The color filter 32B absorbs green light and red light, the color filter 32G absorbs blue light and red light, and the color filter 32R absorbs blue light and green light. The color filter 32 absorbs the remaining three types of light other than transmitted light among blue light, green light, red light, and infrared light.

In the example illustrated in FIGS. 2 and 3, as the fourth light receiving elements 31, fourth light receiving elements 31IR including color filters 32IR that transmit only infrared light are arranged.

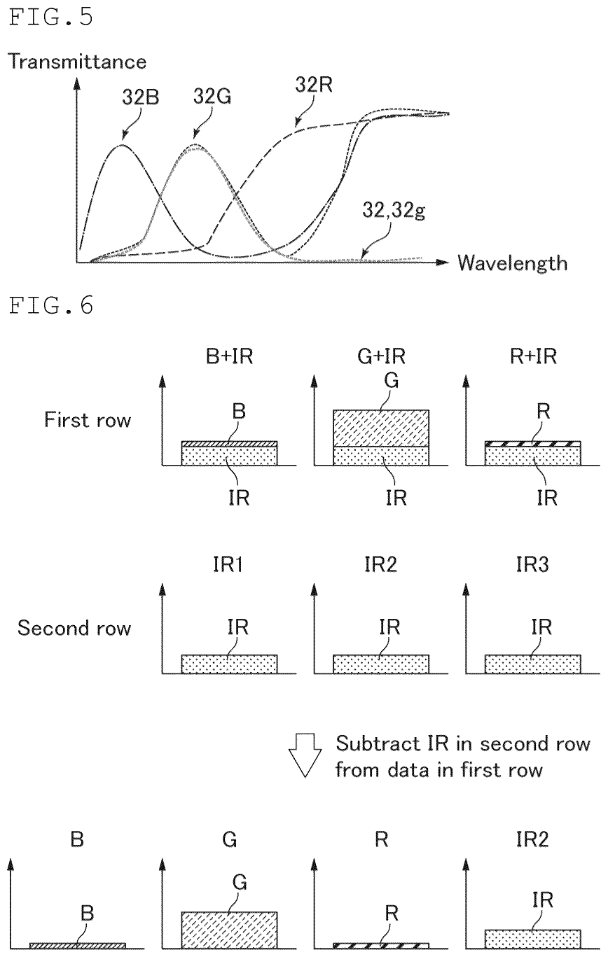

Further, in the present embodiment, as the fourth light receiving elements 31, fourth light receiving elements including a color filter that transmits only any one of blue light, green light, or red light may be arranged. In the example illustrated in FIGS. 4 and 5, as the fourth light receiving elements 31, fourth light receiving elements 31g including color filters 32g that transmit only green light may be arranged.

The light receiving unit 13 including such a filter configuration (color filters 32B, 32G, 32R, and 32) is easier to manufacture than a light receiving unit having a conventional filter configuration (for example, the filter configuration used in a second embodiment of JP 6469370 B). Further, as described in detail later, the light amount for each wavelength band detected by each light receiving element, specifically, the amount of blue light, the amount of green light, the amount of red light, and the amount of infrared light can be calculated by simple arithmetic processing using the output values of the light receiving elements that have simultaneously received the light coming from the banknote BN. Therefore, according to the present embodiment, visible range data and infrared range data can be simultaneously acquired without using a filter configuration that is difficult to manufacture.

The “light amount” is a value that varies depending on the amount of light incident to the light receiving unit (light reception amount).

Next, calculation processing executed by the recognition unit 23 using the output value of each light receiving element will be described.

The recognition unit 23 may subtract the output value of the fourth light receiving element 31 from at least one of the output value of the first light receiving element 31B, the output value of the second light receiving element 31G, or the output value of the third light receiving element 31R, and recognize the banknote BN to be recognized using the subtraction result. Since the color filter 32B, the color filter 32G, and the color filter 32R transmit visible light and infrared light, the output values of the first to third light receiving elements are values corresponding to the sum of the amount of received visible light and the amount of received infrared light. However, since the color filter 32 of the fourth light receiving element 31 transmits only any one of (hereinafter, also referred to as specific monochromatic light) blue light, green light, red light, or infrared light, the output value of the fourth light receiving element 31 is a value that depends only on the amount of specific monochromatic light. Therefore, in a case where the specific monochromatic light is the infrared light, only the output due to the infrared light is canceled from the outputs of the first to third light receiving elements, and the amount of blue light, the amount of green light, and the amount of red light are calculated in the subtraction processing. In this case, the recognition unit 23 can recognize the banknote BN to be recognized, based on the amount of blue light, the amount of green light, and the amount of red light, which are results of the subtraction processing, and the amount of infrared light, which is the output value of the fourth light receiving element 31. Further, in a case where the specific monochromatic light is blue light, green light, or red light, only the output due to the specific monochromatic light is canceled from the output from any one of the first to third light receiving elements that receive the same light as the specific monochromatic light, and the amount of the infrared light is calculated in the subtraction processing. In this case, the recognition unit 23 can recognize the banknote BN to be recognized, based on the amount of infrared light, which is the result of the subtraction processing, and the amount of the specific monochromatic light, which is the output value of the fourth light receiving element 31.

When the color filters 32 of the fourth light receiving elements 31 transmit only infrared light, that is, when the fourth light receiving elements 31IR including the color filters 32IR that transmit only infrared light is arranged as the fourth light receiving elements 31 (see FIGS. 2 and 3), the recognition unit 23 may subtract the output values of the fourth light receiving elements 31IR from at least one of the output values of the first light receiving element 31B, the second light receiving element 31G, or the third light receiving element 31R to calculate at least one of the amount of blue light, the amount of green light, or the amount of red light as the subtraction result.

In this case, as illustrated in the first column of FIG. 6, the output from the first light receiving element 31B, the output from the second light receiving element 31G, and the output from the third light receiving element 31R each include a component (IR) due to the amount of infrared light in addition to the corresponding component (B, G, or R) due to the amount of visible light. On the other hand, as illustrated in the second column of FIG. 6, the outputs from the fourth light receiving elements 31IR each include only the component (IR) due to the amount of infrared light. Therefore, the amount (B) of only blue light, the amount (G) of only green light, and the amount (R) of only red light can be calculated as illustrated in the third column of FIG. 6 by subtracting the output value of the fourth light receiving element 31IR from the output value of the first light receiving element 31B, the output value of the second light receiving element 31G, and the output value of the third light receiving element 31R.

In a case where the color filters 32 of the fourth light receiving elements 31 transmit only green light, that is, in a case where the fourth light receiving elements 31g including the color filters 32g that transmit only green light are arranged as the fourth light receiving elements 31 (see FIGS. 4 and 5), the recognition unit 23 may subtract the output value of the fourth light receiving element 31g from the output value of the second light receiving element 31G to calculate the amount of infrared light as the subtraction result.

In this case, the recognition unit 23 may subtract the amount of the infrared light from at least one of the output value of the first light receiving element 31B or the output value of the third light receiving element 31R to further calculate at least one of the amount of blue light or the amount of red light as the subtraction result.

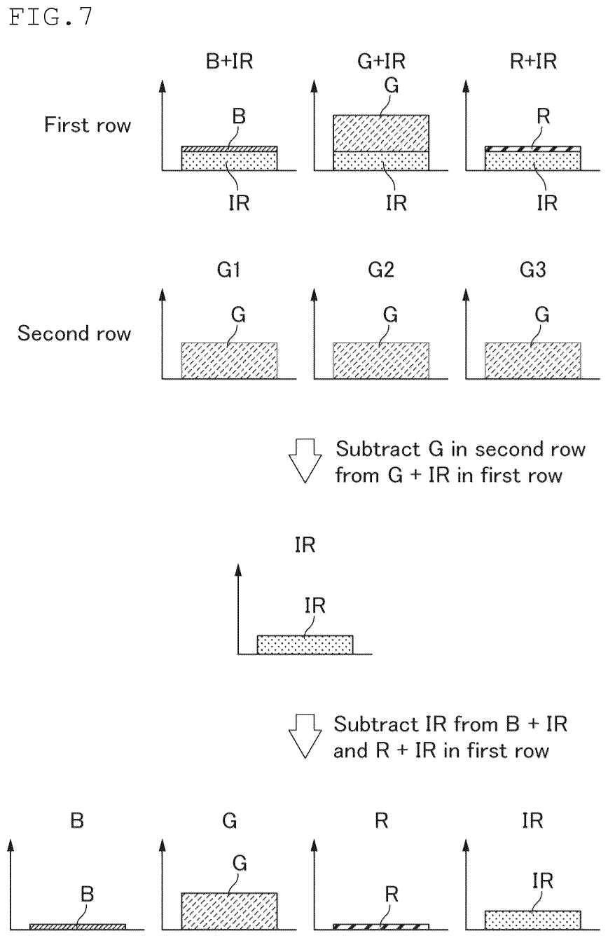

That is, as illustrated in the first column of FIG. 7, the output from the first light receiving element 31B, the output from the second light receiving element 31G, and the output from the third light receiving element 31R each include a component (IR) due to the amount of infrared light in addition to the corresponding component (B, G, or R) due to the visible light amount. However, as illustrated in the second column of FIG. 7, the outputs from the fourth light receiving elements 31g each include only a component (G) due to the amount of green light. Therefore, the output value of the fourth light receiving element 31g are subtracted from the output value of the second light receiving element 31G, the amount (IR) of only the infrared light can be calculated as illustrated in the third column of FIG. 7. The amount (B) of only blue light, and the amount (R) of only red light can be calculated as illustrated in the fourth column of FIG. 7 by subtracting the calculated amount of only infrared light from the output value of the first light receiving element 31B and the output value of the third light receiving element 31R.

In a case where the amount of green light is used for the recognition processing, the output values of the fourth light receiving elements 31g may be used as they are, or the amount of only green light may be calculated by subtracting the amount of the infrared light from the output value of the second light receiving element 31G, and used.

Similarly, in a case where the color filters 32 of the fourth light receiving elements 31 transmit only blue light, that is, in a case where the fourth light receiving elements including the color filters that transmit only blue light are arranged as the fourth light receiving elements 31, the recognition unit 23 may subtract the output value of the fourth light receiving element 31 from the output value of the first light receiving element 31B to calculate the amount of infrared light as the subtraction result.

In this case, the recognition unit 23 may further calculate at least one of the amount of green light or the amount of red light as the subtraction result by subtracting the calculated amount of the infrared light from at least one of the output value of the second light receiving element 31G or the output value of the third light receiving element 31R.

In this case, in a case where the amount of blue light is used for the recognition processing, the output values of the fourth light receiving elements 31 may be used as they are, or the amount of only blue light may be calculated by subtracting the amount of infrared light from the output value of the first light receiving element 31B, and used.

Similarly, in a case where the color filters 32 of the fourth light receiving elements 31 transmit only red light, that is, in a case where the fourth light receiving elements including the color filters that transmit only red light are arranged as the fourth light receiving elements 31, the recognition unit 23 may subtract the output value of the fourth light receiving element 31 from the output value of the third light receiving element 31R to calculate the amount of infrared light as the subtraction result.

In this case, the recognition unit 23 may subtract the calculated amount of the infrared light from at least one of the output value of the first light receiving element 31B or the output value of the second light receiving element 31G to further calculate at least one of the amount of blue light or the amount of green light as the subtraction result.

In this case, in a case where the amount of red light is used for the recognition processing, the output values of the fourth light receiving elements 31 may be used as they are, or the amount of only red light may be calculated by subtracting the amount of infrared light from the output value of the third light receiving element 31R, and used.

The recognition unit 23 may calculate all of the amount of blue light, the amount of green light, the amount of red light, and the amount of infrared light in the subtraction processing, but may calculate, in the subtraction processing, only the light amount used for the recognition processing, and use the light amount.

That is, the recognition unit 23 may recognize the banknote BN to be recognized, based on at least one of the amount of blue light, the amount of green light, the amount of red light, or the amount of infrared light that can be calculated as the subtraction result. The recognition unit 23 may recognize the banknote BN to be recognized, based on the light amounts themselves. Further, the recognition unit 23 may recognize the banknote BN to be recognized, based on a ratio (for example, a ratio between the amount of green light and the amount of infrared light, or a ratio between the amount of red light and the amount of infrared light) of at least one set of the amounts of blue light, green light, red light, or infrared light. These amounts can be calculated as the subtraction result.

In this manner, the recognition unit 23 may recognize the banknote BN using the calculated light amount itself, or may recognize the banknote BN using an evaluation value (for example, a ratio or a sum) based on the calculated light amount.

In either case, the recognition unit 23 may recognize the banknote BN, for example, determine the authenticity or presence or absence of a fluorescent ink depending on whether the calculated light amount or the evaluation value thereof is within an allowable range with respect to reference data.

The “reference data” referred to by the recognition unit 23 is information for defining a standard (for example, a threshold) regarding a (genuine) light amount acceptable as a genuine banknote. The information may include, for example, an upper limit value and a lower limit value of the light amount or the evaluation value thereof detected from a genuine banknote. When a determination is made whether a certain light amount or an evaluation value thereof is within the allowable range with respect to the reference data, the determination may be made whether the light amount or the evaluation value thereof is between the upper limit value and the lower limit value of a light amount or an evaluation value thereof defined by the reference data.

The arrangement of the first to fourth light receiving elements will be described below.

The arrangement of the first to fourth light receiving elements is not limited, but as illustrated in FIGS. 2 and 4, the first to fourth light receiving elements may be arranged in two rows.

More specifically, the first light receiving element 31B, the second light receiving element 31G, and the third light receiving element 31R may be arranged in one row along a first reference line L1 parallel to the Y direction (main scanning direction). The fourth light receiving elements 31 may be arranged in one row along a second reference line L2 that is parallel to the Y direction (main scanning direction) and is at a position shifted from the first reference line L1 to the X direction (sub-scanning direction). Thus, the first to third light receiving elements can be constituted by a line sensor including a general RGB color filter. The line sensor including the fourth light receiving elements 31 can be more easily manufactured by arranging the fourth light receiving elements 31 in another row. The fourth light receiving elements 31 each includes the color filter 32 that transmits only a specific monochromatic light. The color filters 32 may require manufacturing processing different from that of the color filter 32B, the color filter 32G, and the color filter 32R.

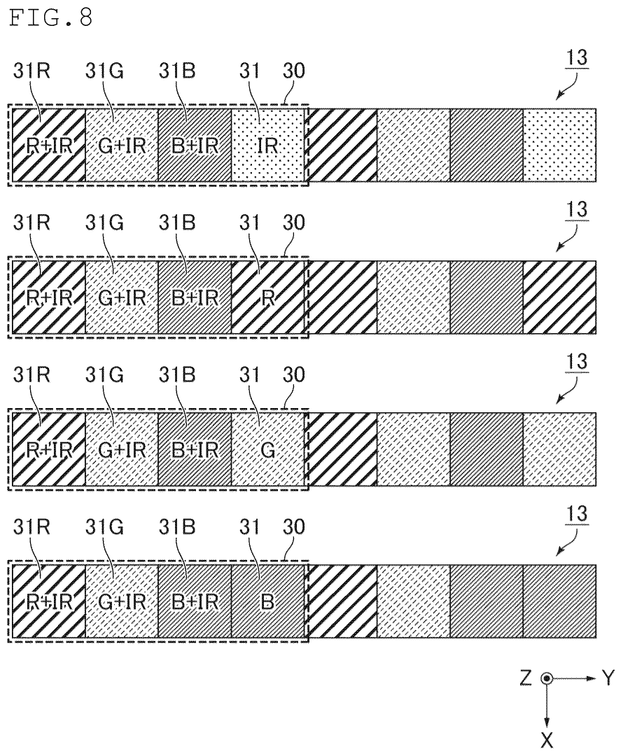

As illustrated in the first to fourth columns of FIG. 8, the first to fourth light receiving elements may be arranged in one row.

That is, the first light receiving elements 31B, the second light receiving elements 31G, the third light receiving elements 31R, and the fourth light receiving elements 31 may be arranged in a row in the Y direction (main scanning direction).

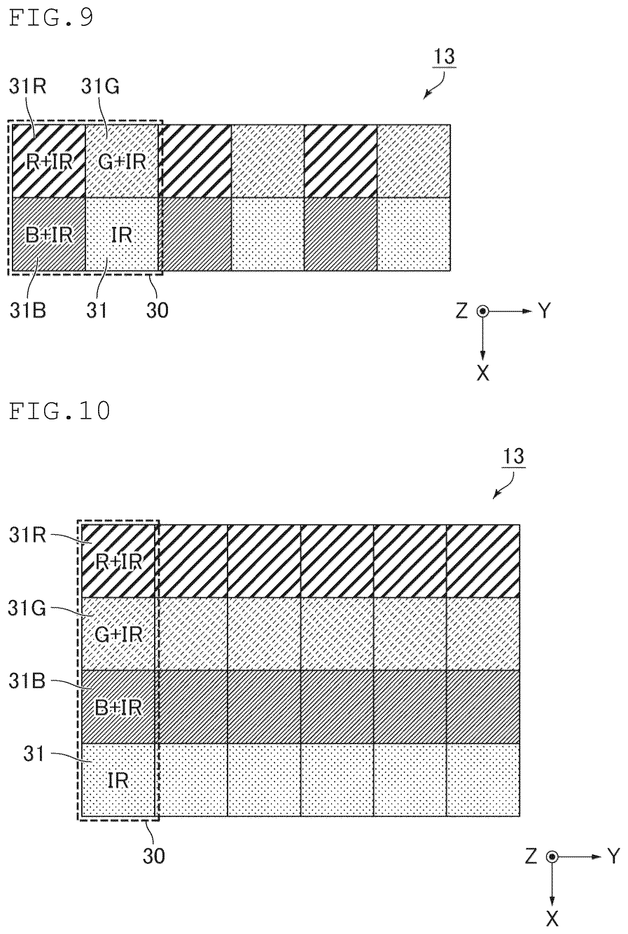

As illustrated in FIG. 9, the first light receiving elements 31B, the second light receiving elements 31G, the third light receiving elements 31R, and the fourth light receiving elements 31 may be arranged in 2×2 per pixel.

Further, as illustrated in FIG. 10, the first light receiving elements 31B, the second light receiving elements 31G, the third light receiving elements 31R, and the fourth light receiving elements 31 may be arranged in four rows per pixel.

In either case, the light receiving unit 13 may include a plurality of pixels 30 arranged in a row in the Y direction (main scanning direction), and each pixel 30 may include the first to fourth light receiving elements.

In a case where the first to third light receiving elements and the fourth light receiving elements are arranged in two rows, in FIGS. 2 and 4, the fourth light receiving elements 31 are arranged at positions corresponding to the first to third light receiving elements in the Y direction (main scanning direction). The output resolution of the fourth light receiving elements 31 is set to be three times the output resolution of each of the first to third light receiving elements. However, at least one fourth light receiving element 31 may be provided for the first to third light receiving elements. That is, at least one fourth light receiving element 31 may be provided in each pixel 30.

In a case where the plurality of fourth light receiving elements 31 is provided for the first to third light receiving elements (each pixel 30), the output value of the fourth light receiving element 31 used in the above-described subtraction processing may be the output value of only any one of the fourth light receiving elements 31, or may be a representative value (for example, an average value) of the output values of the plurality of fourth light receiving elements 31.

In a case where the total number of the fourth light receiving elements 31 constituting one pixel 30 is smaller than the total number of the first to third light receiving elements constituting the pixel 30, the light receiving area of each of the fourth light receiving elements 31 may be substantially identical to the light receiving area of each of the first to third light receiving elements, or may be larger than the light receiving area of each of the first to third light receiving elements. In the latter case, the output value of each of the fourth light receiving elements 31 may be divided by the ratio of the light receiving area of each of the first to third light receiving elements to the light receiving area of each of the fourth light receiving elements 31, and the division result may be used for the above-described subtraction processing.

The light receiving element (imaging element) means an element where light intensity in a predetermined wavelength band (converts into an electric signal). The light receiving element may include a photodetector such as a photodiode, and a color filter (color resist) that is disposed on a light receiving surface of the photodetector and reduces transmission of light with wavelength bands (for example, green and red wavelength bands) excluding predetermined wavelength bands (for example, blue and infrared wavelength bands) to be detected.

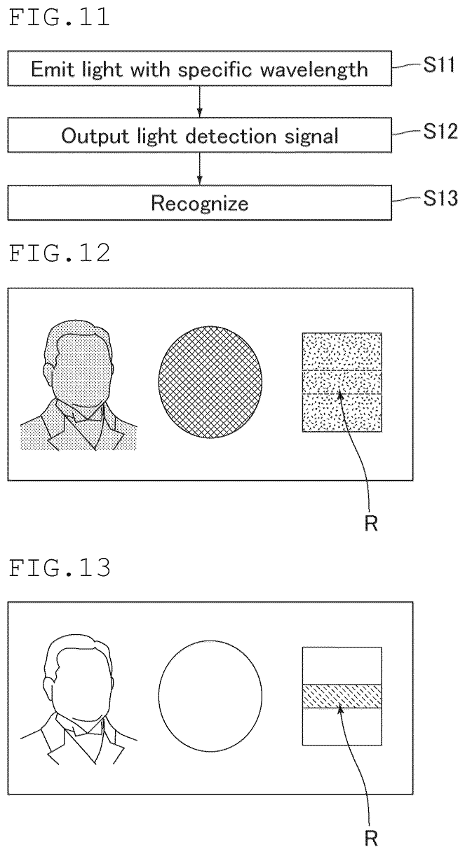

An operation of the sheet recognition unit 1 according to the present embodiment will be described below with reference to FIG. 11.

As illustrated in FIG. 11, first, the light source 11 emits at least light with a specific wavelength to the banknote BN to be recognized (step S11).

The light receiving unit 13 receives light coming from the banknote BN to be recognized, the banknote being irradiated with the light with a specific wavelength, and outputs a light detection signal (step S12).

The light receiving unit 13 includes a first light receiving element 31B including a color filter 32B that transmits blue light and infrared light, a second light receiving element 31G including a color filter 32G that transmits green light and infrared light, a third light receiving element 31R including a color filter 32R that transmits red light and infrared light, and a fourth light receiving element 31 including a color filter 32 that transmits only one of blue light, green light, red light, or infrared light (see FIGS. 2 to 5 and FIGS. 8 to 10).

Thereafter, the recognition unit 23 recognizes the banknote BN to be recognized using the light detection signal output from the light receiving unit 13 (step S13), and the operation of the sheet recognition unit 1 ends.

In step S13, the recognition unit 23 may execute the above-described subtraction processing and recognize the banknote BN using the subtraction result.

Note that the recognition unit 23 may be operated by a control unit (processing circuitry), described later, executing an appropriate program.

### Second Embodiment

In the present embodiment, a case where photoluminescence coming from a banknote BN to be recognized is detected will be described.

In this specification, photoluminescence is a concept containing fluorescence and phosphorescence, but hereinafter, a case of detecting fluorescence (photoluminescence that can be detected during emission of excitation light) as photoluminescence will be described. That is, in the following description, “photoluminescence”, “photoluminescence detection signal”, “photoluminescence emission amount”, “photoluminescent ink”, “visible photoluminescent ink”, and “infrared photoluminescent ink” are respectively “fluorescence”, “fluorescence detection signal”, “fluorescence emission amount”, “fluorescent ink”, “visible fluorescent ink”, and “infrared fluorescent ink”.

First, a genuine banknote to be compared with a banknote to be recognized will be described in the present embodiment. As illustrated in FIGS. 12 and 13, fluorescent ink to be authenticated is printed in a predetermined region R on a genuine banknote.

The fluorescent ink contains at least one type of photoluminescent compound, for example, two or more photoluminescent compounds. During emission of ultraviolet light as excitation light, fluorescence is emitted at a predetermined wavelength band including at least a visible range and an infrared range. The fluorescence spectrum of the fluorescent ink may have peaks in the visible range and the infrared range, respectively. Hereinafter, the fluorescent ink may be referred to as a special fluorescent ink.

On the other hand, the special fluorescent ink hardly emits light even when visible light is emitted, and transmits visible light. Therefore, the special fluorescent ink is not visually recognized by human eyes in a situation where visible light is emitted, for example, under natural light or under general artificial illumination (see FIG. 12). In a case where ultraviolet light is emitted to the special fluorescent ink, a fluorescent component that emits light in the visible range can be visually recognized by human eyes (see FIG. 13). However, even in this case, a fluorescent component that emits light in the infrared range cannot be visually recognized by human eyes. Therefore, the special fluorescent ink can function as a highly secure security element.

For example, ink containing a mixture of a photoluminescent compound that emits fluorescence in the visible range and a photoluminescent compound that emits fluorescence in the infrared range may be printed on a printing portion of the special fluorescent ink. Alternatively, ink containing the photoluminescent compound that emits fluorescence in the visible range and ink containing the photoluminescent compound that emits fluorescence in the infrared range may be applied to be superimposed on the printing portion.

The sheet recognition unit according to the present embodiment detects fluorescence generated from a banknote BN to be recognized, and includes a light source 11, a light receiving unit (light sensor) 13, and a recognition unit 23 (see FIG. 1) similarly to the sheet recognition unit 1 according to the first embodiment. Light with a specific wavelength emitted from the light source 11 is ultraviolet light. The light receiving unit 13 receives fluorescence emitted from the banknote BN to be recognized, the banknote being irradiated with the ultraviolet light, and outputs a fluorescence detection signal as a light detection signal. The recognition unit 23 recognizes the banknote BN to be recognized, using the fluorescence detection signal output from the light receiving unit 13. The sheet recognition unit according to the present embodiment can recognize the banknote BN to be recognized, based on fluorescence emitted from the banknote BN to be recognized.

The recognition unit 23 recognizes the banknote BN to be recognized, based on whether a visible fluorescence emission amount and an infrared fluorescence emission amount of the banknote BN to be recognized are within an allowable range with respect to the reference data related to a visible fluorescence emission amount and an infrared fluorescence emission amount in a genuine banknote. Therefore, an authentication can be made for special fluorescent ink that emits fluorescence in a predetermined wavelength band including at least the visible region and the infrared region. That is, the sheet recognition unit according to the present embodiment makes it possible to mechanically recognize a banknote having a high security property using a photoluminescent compound. As described above, the recognition unit 23 may authenticate the banknote BN to be recognized.

The “fluorescence emission amount” is a value indicating the intensity (brightness) of fluorescence.

The light source 11 emits ultraviolet light as excitation light to the banknote BN in the present embodiment. The light source 11 may be disposed on the same side as the light receiving unit 13 with respect to the banknote BN.

In the present embodiment, the light receiving unit 13 is configured to be able to receive fluorescence emitted from a special fluorescent ink of the banknote BN to be recognized while ultraviolet light is being emitted. That is, the light receiving unit 13 is configured to be able to detect a fluorescent component in the visible range, the component being emitted from the special fluorescent ink, and a fluorescent component in the infrared range, the component being emitted from the special fluorescent ink. At this time, the light receiving unit 13 can function as a sensor having sensitivity at least in the wavelength band (the visible range and infrared range) of the fluorescence emitted from the special fluorescent ink. The fluorescence detection signal is an electric signal corresponding to the incident light amount of the fluorescence emitted from the banknote BN during a turn-on period of the ultraviolet light.

In the present embodiment, the fluorescence emission amount of visible light and the fluorescence emission amount of infrared light of the banknote BN to be recognized correspond to the light amount of visible light (the amount of blue light, the amount of green light and/or the amount of red light) and the amount of infrared light acquired by the subtraction processing described in the first embodiment. That is, the fluorescence emission amount of visible light and the fluorescence emission amount of infrared light of the banknote BN to be recognized can be calculated by the subtraction processing using the output values of the first to fourth light receiving elements when the fluorescence generated from the banknote BN to be recognized is received. In other words, in the present embodiment, the recognition unit 23 executes the subtraction processing on the fluorescence detection signal acquired by the light receiving unit 13 receiving the fluorescence emitted from the banknote BN that is to be recognized and has been irradiated with ultraviolet light, to calculate the visible fluorescence emission amount and the infrared fluorescence emission amount of the banknote BN to be recognized. The recognition unit 23 then recognizes the banknote BN to be recognized, based on whether the calculated visible fluorescence emission amount and infrared fluorescence emission amount are within an allowable range with respect to reference data.

In the present embodiment, the “reference data” referred to by the recognition unit 23 is information for defining a standard (for example, a threshold) regarding the (genuine) visible fluorescence emission amount and the (genuine) infrared fluorescence emission amount acceptable as a genuine banknote. The information may include, for example, an upper limit value and a lower limit value of each of the visible fluorescence emission amount and the infrared fluorescence emission amount. When a determination is made whether a certain fluorescence emission amount is within the allowable range with respect to the reference data, the determination may be made whether the fluorescence emission amount is between the upper limit value and the lower limit value of the fluorescence emission amount defined by the reference data.

The reference data may include a ratio between the visible fluorescence emission amount and the infrared fluorescence emission amount of the genuine banknote BN. In this case, the recognition unit 23 may calculate the ratio between the visible fluorescence emission amount and the infrared fluorescence emission amount of the banknote to be recognized, and recognize the banknote to be recognized, based on whether the ratio is within an allowable range with respect to the ratio included in the reference data. Thus, the authentication of special fluorescent ink can be performed with higher accuracy.

Hereinafter, the ratio between the visible fluorescence emission amount and the infrared fluorescence emission amount may be simply referred to as a fluorescence emission ratio. Note that the fluorescence emission ratio may be obtained by dividing the visible fluorescence emission amount by the infrared fluorescence emission amount or by dividing the infrared fluorescence emission amount by the visible fluorescence emission amount. Alternatively, the fluorescence emission ratio may be a percentage thereof.

In the case of using the fluorescence emission ratio, the reference data may include an upper limit value and a lower limit value of the (genuine) fluorescence emission ratio acceptable as a genuine banknote. The recognition unit 23 may determine whether the fluorescence emission ratio of the banknote to be recognized is between the upper limit value and the lower limit value of the fluorescence emission ratio defined by the reference data.

As for the special fluorescent ink, the fluorescence spectrum may have a peak in at least one of a blue wavelength band, a green wavelength band, or a red wavelength band. In the visible range, the fluorescence spectrum may have a peak only in one of the blue wavelength band, the green wavelength band, or the red wavelength band.

The light receiving unit 13 may receive at least one of blue, green, or red fluorescence as the visible fluorescence and output a fluorescence detection signal of the at least one color. The reference data may relate to a fluorescence emission amount of the at least one color and an infrared fluorescence emission amount. The recognition unit 23 may recognize the banknote to be recognized based on whether the fluorescence emission amount of the at least one color and the infrared fluorescence emission amount of the banknote to be recognized are within the allowable range with respect to the reference data. This makes it possible to authenticate the special fluorescent ink having a peak in at least one of the blue wavelength band, the green wavelength band, or the red wavelength band in the fluorescence spectrum.

More specifically, the light receiving unit 13 may receive the green fluorescence as the visible fluorescence and output a green fluorescence detection signal. The reference data may relate to a green fluorescence emission amount and an infrared fluorescence emission amount. The recognition unit 23 may recognize the banknote to be recognized based on whether the green fluorescence emission amount and the infrared fluorescence emission amount of the banknote to be recognized are within the allowable range with respect to the reference data.

The light receiving unit 13 may receive red fluorescence as the visible fluorescence and output a red fluorescence detection signal. The reference data may relate to a red fluorescence emission amount and an infrared fluorescence emission amount. The recognition unit 23 may recognize the banknote to be recognized based on whether the red fluorescence emission amount and the infrared fluorescence emission amount of the banknote to be recognized are within the allowable range with respect to the reference data.

Further, the light receiving unit 13 may receive blue fluorescence as the visible fluorescence and output a blue fluorescence detection signal. The reference data may relate to a blue fluorescence emission amount and an infrared fluorescence emission amount. The recognition unit 23 may recognize the banknote to be recognized based on whether the blue fluorescence emission amount and the infrared fluorescence emission amount of the banknote to be recognized are within the allowable range with respect to the reference data.

As for the special fluorescent ink, the fluorescence spectrum may have a peak in the infrared region, or may have a peak in the near infrared range.

The light receiving unit 13 may receive near-infrared fluorescence as the infrared fluorescence and output a near-infrared fluorescence detection signal. The reference data may relate to a visible fluorescence emission amount and a near-infrared fluorescence emission amount. The recognition unit 23 may recognize the banknote to be recognized based on whether the visible fluorescence emission amount and the near-infrared fluorescence emission amount of the banknote to be recognized are within the allowable range with respect to the reference data. This makes it possible to authenticate the special fluorescent ink having a peak in the near-infrared wavelength band in the fluorescence spectrum.

An operation of the sheet recognition unit according to the present embodiment will be described below with reference to FIG. 14.

As illustrated in FIG. 14, first, the light source 11 emits at least ultraviolet light to the banknote BN to be recognized (step S21).

The light receiving unit 13 receives fluorescence emitted from the banknote BN to be recognized, the banknote being irradiated with the ultraviolet light, and outputs a fluorescence detection signal (step S22).

Similarly to the first embodiment, the light receiving unit 13 includes a first light receiving element 31B including a color filter 32B that transmits blue light and infrared light, a second light receiving element 31G including a color filter 32G that transmits green light and infrared light, a third light receiving element 31R including a color filter 32R that transmits red light and infrared light, and a fourth light receiving element 31 including a color filter 32 that transmits only one of blue light, green light, red light, or infrared light (see FIGS. 2 to 5 and FIGS. 8 to 10).

Thereafter, the recognition unit 23 recognizes the banknote BN to be recognized (step S23) using the fluorescence detection signal output from the light receiving unit 13, based on whether the visible fluorescence emission amount and the infrared fluorescence emission amount of the banknote BN to be recognized are within the allowable range with respect to the reference data related to a visible fluorescence emission amount and an infrared fluorescence emission amount in a genuine banknote. The operation of the sheet recognition unit according to the present embodiment is then ended.

Note that the recognition unit 23 may be operated by a control unit (processing circuitry), described later, executing an appropriate program also in the present embodiment.

### Third Embodiment

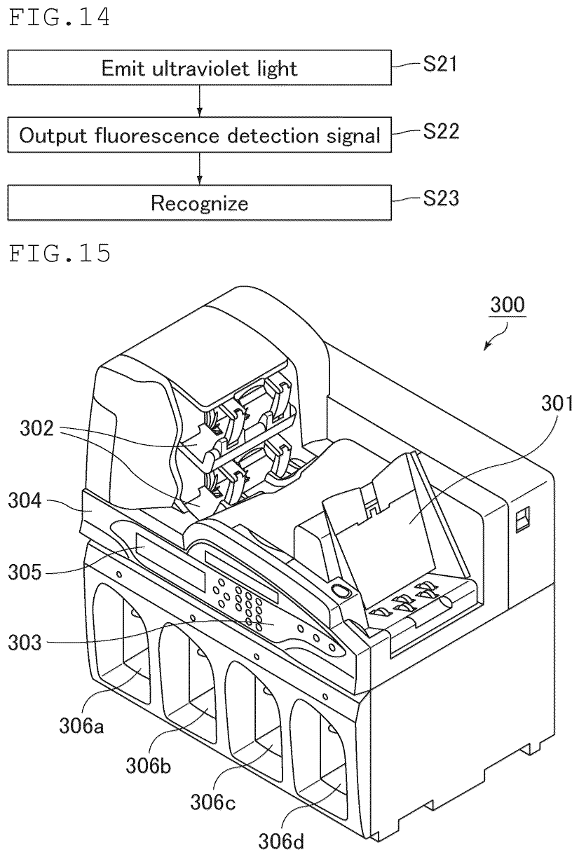

A sheet handling device according to the present embodiment may have, for example, a configuration illustrated in FIG. 15. A sheet handling device 300 illustrated in FIG. 15 is a small sheet handling device installed and used on a table. This device includes a sheet recognition unit (not illustrated in FIG. 15), a hopper 301, two rejection units 302, an operation unit 303, four stacking units 306a to 306d, and a display unit 305. The sheet recognition unit executes banknote recognition processing. On the hopper 301, a plurality of banknotes to be handled is placed in a stacked state. The rejection units 302 reject a rejection banknote when the banknote fed from the hopper 301 into a housing 304 is a rejection banknote, such as a counterfeit note or a suspect note. The operation unit 303 is for inputting an instruction from an operator. The stacking units 306a to 306d are for sorting and stacking banknotes whose denominations, authenticity, and fitness have been recognized in the housing 304. The display unit 305 is for displaying information such as recognition and count results of banknotes and the stacking statuses of the stacking units 306a to 306d. Among the four stacking units 306a to 306d, fit notes are stored in the stacking units 306a to 306c, and soiled notes are stored in the stacking unit 306d based on the result of the fitness determination by the sheet recognition unit. A method for distributing banknotes into the stacking units 306a to 306d can be optionally set.

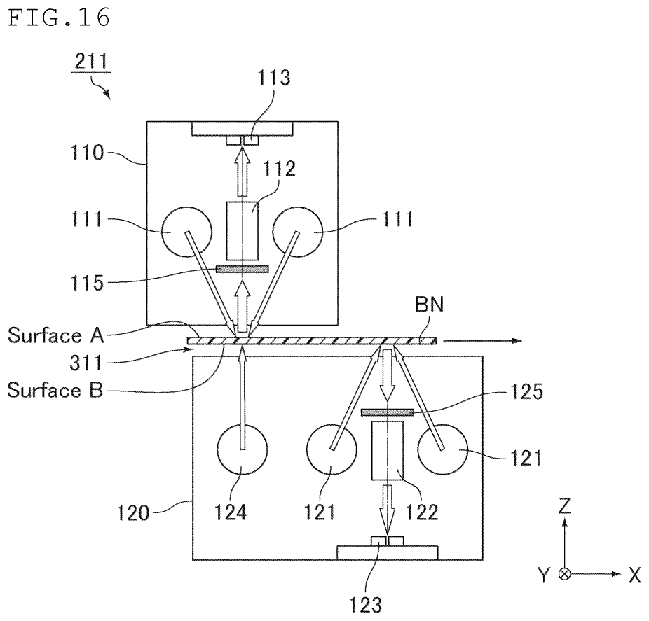

A configuration of an imaging unit that is a main unit of the sheet recognition unit according to the present embodiment will be described below with reference to FIG. 16. As illustrated in FIG. 16, an imaging unit 211 includes an upper unit 110 and a lower unit 120 disposed to face each other. A gap through which a banknote BN is transported in an X direction in an XY plane is formed between the upper unit 110 and the lower unit 120 separated from each other in a Z direction. This gap constitutes a part of a transport path of the sheet handling device according to the present embodiment. The upper unit 110 and the lower unit 120 are positioned on the upper side (+Z direction) and the lower side (−Z direction) of the transport path, respectively. The Y direction corresponds to a main scanning direction of the imaging unit 211, and the X direction corresponds to a sub-scanning direction of the imaging unit 211.

As illustrated in FIG. 16, the upper unit 110 includes two light sources 111 for reflection, a condensing lens 112, a light receiving unit (light sensor) 113, and an UV-cutting film 115. The light source 111 for reflection sequentially irradiates a main surface (hereinafter, surface A) of the banknote BN on the light receiving unit 113 side with irradiation light, specifically, infrared light, white light including red light, green light, and blue light, and ultraviolet light as excitation light for fluorescence having different wavelength bands. The condensing lens 112 condenses light emitted from the light source 111 for reflection and reflected from the surface A of the banknote BN, light emitted from a light source 124 for transmission disposed in the lower unit 120 and transmitted through the banknote BN, and fluorescence emitted on the surface A of the banknote BN. The light receiving unit 113 receives the light condensed by the condensing lens 112 and converts the light into an electric signal. After the electric signal is amplified, the electric signal is A-D converted into digital data and then the digital data is output. Here, the light received by the light receiving unit is also referred to as incident light, and the light emitted from the light source is also referred to as irradiation light. The UV-cutting film 115 absorbs ultraviolet light emitted from the light source 111 for reflection and reflected by the surface A of the banknote BN, and prevents the ultraviolet light from being received by the light receiving unit 113 via the condensing lens 112.

The lower unit 120 includes two light sources 121 for reflection, one light source 124 for transmission, a condensing lens 122, a light receiving unit (light sensor) 123 and a UV-cutting film 125. The light source 121 for reflection sequentially irradiates a main surface (hereinafter, surface B) of the banknote BN on the light receiving unit 123 side with irradiation light having different wavelength bands, specifically, infrared light, white light including red light, green light, and blue light, and ultraviolet light as excitation light for fluorescence. The condensing lens 122 condenses light emitted from the light source 121 for reflection and reflected from the surface B of the banknote BN, and the fluorescence emitted on the surface B of the banknote BN. The light receiving unit 123 receives the light condensed by the condensing lens 122 and converts the light into an electric signal. After the electric signal is amplified, the electric signal is A-D converted into digital data and then the digital data is output. The UV-cutting film 125 absorbs ultraviolet light emitted from the light source 121 for reflection and reflected by the surface B of the banknote BN, and prevents the ultraviolet light from being received by the light receiving unit 123 via the condensing lens 122.

The light source 124 for transmission is disposed on an optical axis of the condensing lens 112 of the upper unit 110. The light emitted from the light source 124 for transmission is partially transmitted through the banknote BN, is condensed by the condensing lens 112 of the upper unit 110, and is detected by the light receiving unit 113. The light source 124 for transmission may sequentially or simultaneously irradiate the surface B of the banknote BN with irradiation light having different wavelength bands.

In this specification, light having different wavelength bands (irradiation light, incident light, etc.) is, for example, light having different colors as visible light, and is light having wavelength bands partially overlapping or light having non-overlapping wavelength bands as infrared light and ultraviolet light.

Each of the light sources 111, 121, and 124 includes a linear light guide (not illustrated) extending in a direction (the main scanning direction, i.e. the Y direction) perpendicular to the sheet surface of FIG. 16, and a plurality of light-emitting diode (LED) elements (not illustrated) disposed at both ends (or one end) of the light guide.

Each of the light sources 111 and 121 may include an LED element that emits infrared light having a peak wavelength of 750 nm or more, an LED element that emits red light (R) having a peak wavelength of 600 nm or more and less than 750 nm, an LED element that emits green light (G) having a peak wavelength of 500 nm or more and less than 600 nm, an LED element that emits blue light (B) having a peak wavelength of 400 nm or more and less than 500 nm, and an LED element that emits ultraviolet light (UV) having a peak wavelength of less than 400 nm. One light source 111 is disposed on each of the upstream side and downstream side in the transport direction with the condensing lens 112 being interposed therebetween. One light source 121 is disposed on each of the upstream side and downstream side in the transport direction with the condensing lens 122 being interposed therebetween.

The light source 124 may include a plurality of LED elements that emit light having peak wavelengths different from each other. Note that the peak wavelength means a wavelength at which light emission intensity is maximum.

As illustrated in FIGS. 2 and 4, each of the light receiving units 113 and 123 includes a plurality of pixels 30 arranged in a row in the main scanning direction (direction orthogonal to the transport direction of the banknote BN, i.e. the Y direction). Each pixel 30 includes a row of first light receiving element 31B, second light receiving element 31G, and third light receiving element 31R, and a row of fourth light receiving elements 31.

FIG. 16 illustrates a case where an image is formed in the range of the light receiving elements in two rows by one condensing lens, but the condensing lens that forms an image in each range of the light receiving elements in each row may be disposed. That is, the two rows of condensing lenses may be arranged to face the two rows of light receiving elements, respectively.

Each of the upper unit 110 and the lower unit 120 repeatedly images the banknote BN transported in the transport direction and outputs a signal that depends on a light receiving amount. As a result, the imaging unit 211 acquires an image of the entire banknote BN. Specifically, the imaging unit 211 acquires a transmissive light image of the banknote BN and a reflective light image of the surface A based on the output signal from the upper unit 110, and acquires a reflective light image of the surface B of the banknote BN based on the output signal from the lower unit 120.

The imaging unit 211 further acquires a fluorescence detection signal for the entire banknote BN on each of the surface A and the surface B of the banknote BN. That is, the imaging unit 211 can acquire the fluorescent images of the surface A and the surface B of the banknote BN.

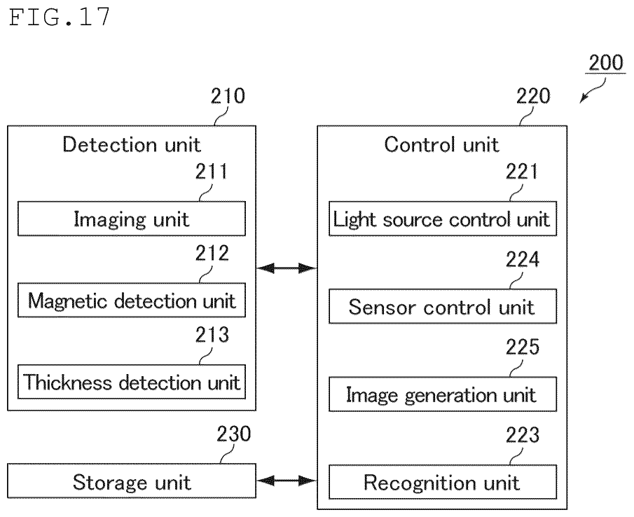

A configuration of the sheet recognition unit according to the present embodiment will be described below with reference to FIG. 17. As illustrated in FIG. 17, a sheet recognition unit 200 according to the present embodiment includes a detection unit 210, a control unit 220, and a storage unit (memory) 230.

The control unit 220 is processing circuitry (processor) that controls respective units of the sheet recognition unit 200. The storage unit 230 stores a program for implementing various types of processing. The control unit 220 executes the program. The control unit 220 may include various types of hardware (for example, a field programmable gate array (FPGA)). The control unit 220 controls respective units of the sheet recognition unit 200 based on signals output from the respective units of the sheet recognition unit 200 and control signals from the control unit 220 in accordance with the program stored in the storage unit 230. The control unit 220 further executes functions as a light source control unit 221, a sensor control unit 224, an image generation unit 225, and a recognition unit 223 in accordance with a program stored in the storage unit 230.

The detection unit 210 includes a magnetic detection unit 212 and a thickness detection unit 213 in addition to the above-described imaging unit 211 along the transport path of a banknote. The imaging unit 211 images a banknote and outputs an image signal (image data) as described above. The magnetic detection unit 212 includes a magnetic sensor (not illustrated) that measures magnetism. The magnetic sensor detects magnetism of magnetic ink, a security thread, etc. printed on a banknote. The magnetic sensor is a magnetic line sensor in which a plurality of magnetic detection elements is arranged in a line. The thickness detection unit 213 includes a thickness detection sensor (not illustrated) that measures a thickness of a banknote. The thickness detection sensor detects tape, multi feed, etc. As for the thickness detection sensor, a sensor disposed at each roller detects a displacement amount during passing of a banknote at rollers facing each other with the transport path interposed therebetween.

The storage unit 230 includes a nonvolatile storage device such as a semiconductor memory or a hard disk, and stores various programs and various data (for example, reference data) for controlling the sheet recognition unit 200. The storage unit 230 further stores, as imaging parameters, a wavelength band of irradiation light emitted from each of the light sources 111, 121, and 124 during one cycle of imaging by the imaging unit 211, a timing of turning on and off each of the light sources 111, 121, and 124, a value of a forward current flowing through the LED elements of each of the light sources 111, 121, and 124, a timing of reading a signal from each of the upper unit 110 and the lower unit 120, and the like.

Note that the imaging in one cycle refers to an imaging pattern in which the wavelength band of the irradiation light emitted from each of the light sources 111, 121, and 124, and the timing of turning on and off each of the light sources 111, 121, and 124, and signal reading are set. An image of the entire banknote is acquired by continuously and repeatedly executing the imaging in one cycle as one period.

The light source control unit 221 makes dynamic lighting control of each of the light sources 111, 121, and 124 in order to capture an individual image of a banknote obtained using each of the light sources 111, 121, and 124. Specifically, the light source control unit 221 controls turning-on and turning-off of the light sources 111, 121, and 124 based on the timing set as the imaging parameter. This control is made using a mechanical clock that changes depending on the transport speed of a banknote and a system clock that is always output at a constant frequency regardless of the transport speed of a banknote.

The sensor control unit 224 controls a timing of reading a signal from each of the upper unit 110 and the lower unit 120 based on the timing set as the imaging parameter, and reads a signal from each of the upper unit 110 and the lower unit 120 in synchronization with the timing of turning on and off the light sources 111, 121, and 124. This control is performed using the mechanical clock and the system clock. The sensor control unit 224 then sequentially stores the read signals, that is, the line data in a ring buffer (line memory) of the storage unit 230.

The line data means data based on a signal obtained by each of the upper unit 110 and the lower unit 120 performing one imaging, and corresponds to data for one row in a horizontal direction (direction orthogonal to the transport direction of a banknote, i.e., the Y direction) of the acquired image.

The image generation unit 225 has a function of generating an image based on various signals related to a banknote acquired from the detection unit 210. Specifically, the image generation unit 225 first decomposes the data (image signal) stored in the ring buffer into data for each condition of light irradiation and light reception. The image generation unit 225 then executes correction processing for cutting a dark output, adjusting gain, and correcting a bright output level in accordance with the characteristic of each piece of decomposed data, generates various types of image data of the banknote, and stores the image data in the storage unit 230.

The recognition unit 223 recognizes the banknote BN to be recognized, using the light detection signal acquired by the imaging unit 211.

More specifically, the recognition unit 223 executes the above-described subtraction processing using the fluorescence detection signal corresponding to a recognition target portion of the fluorescent image to calculate the visible fluorescence emission amount of a specific color (blue, green, or red) and the infrared fluorescence emission amount of the banknote to be recognized. The recognition target portion may be set appropriately for the denomination of a banknote.

The recognition unit 223 then authenticates the banknote BN to be recognized, based on whether the calculated visible fluorescence emission amount and the calculated infrared fluorescence emission amount of the banknote BN to be recognized are within an allowable range with respect to the reference data related to a visible fluorescence emission amount and an infrared fluorescence emission amount in a genuine banknote.

### First Modification

In the above embodiments, the case where the light receiving unit constitutes the optical line sensor that acquires the optical data (optical characteristics) of a banknote in the entire region in the width direction of the transport path has been described. However, the light receiving unit may be a point sensor that acquires the optical data (optical characteristics) of a banknote at one point in the width direction of the transport path.

### Second Modification

In the above embodiments, the case where fluorescence is detected as photoluminescence has been described, but phosphorescence (photoluminescence that can be detected after excitation light is turned off) may be used. In this case, a light receiving unit receives phosphorescence emitted from a banknote to be recognized after ultraviolet light as excitation light is turned off. A phosphorescence detection signal is then output. Similarly to the fluorescence detection signal, the recognition processing can be executed using the phosphorescence detection signal. For example, the banknote to be recognized can be recognized based on whether a visible phosphorescence emission amount and an infrared phosphorescence emission amount of the banknote to be recognized are within an allowable range with respect to reference data related to a visible phosphorescence emission amount and an infrared phosphorescence emission amount in a genuine banknote. This makes it possible to authenticate the phosphorescent ink (special phosphorescent ink) that emits phosphorescence in a predetermined wavelength band including at least a visible range and an infrared range after ultraviolet light as excitation light is emitted. Similarly to the special fluorescent ink, the special phosphorescent ink can also function as a security element with high security because a phosphorescent component that emits light in the infrared region cannot be visually recognized by human eyes.

Although the embodiments have been described above with reference to the drawings, the present disclosure is not limited to the above embodiments. The configurations of the respective embodiments may be appropriately combined or modified without departing from the gist of the present disclosure.

As described above, the present disclosure is a technique useful for simultaneously acquiring visible range data and infrared range data without using a filter configuration that is difficult to manufacture.

What is claimed is:

1. A sheet recognition unit, comprising:
a light source capable of emitting light having a specific wavelength to a sheet to be recognized;
a light sensor that receives light coming from the sheet to be recognized, based on the light from the light source and outputs a light detection signal; and
processing circuitry that recognizes the sheet to be recognized, using the light detection signal output from the light sensor,
the light sensor including a first light receiving element including a color filter that transmits blue light and infrared light, a second light receiving element including a color filter that transmits green light and infrared light, a third light receiving element including a color filter that transmits red light and infrared light, and a fourth light receiving element including a color filter that transmits only one of blue light, green light, red light, or infrared light.

2. The sheet recognition unit according to claim 1,
wherein the processing circuitry subtracts an output value of the fourth light receiving element from at least one of an output value of the first light receiving element, an output value of the second light receiving element, or an output value of the third light receiving element, and recognizes the sheet to be recognized, using a subtraction result.

3. The sheet recognition unit according to claim 2,
wherein the color filter of the fourth light receiving element transmits only infrared light, and
wherein the processing circuitry subtracts the output value of the fourth light receiving element from at least one of the output value of the first light receiving element, the output value of the second light receiving element, or the output value of the third light receiving element to calculate at least one of an amount of blue light, an amount of green light, or an amount of red light as the subtraction result.

4. The sheet recognition unit according to claim 2,
wherein the color filter of the fourth light receiving element transmits only blue light, and
wherein the processing circuitry subtracts the output value of the fourth light receiving element from the output value of the first light receiving element to calculate an amount of infrared light as the subtraction result.

5. The sheet recognition unit according to claim 4,
wherein the processing circuitry subtracts the amount of the infrared light from at least one of the output value of the second light receiving element or the output value of the third light receiving element to further calculate at least one of an amount of green light or an amount of red light as the subtraction result.

6. The sheet recognition unit according to claim 2,
wherein the color filter of the fourth light receiving element transmits only green light, and
wherein the processing circuitry subtracts the output value of the fourth light receiving element from the output value of the second light receiving element to calculate an amount of infrared light as the subtraction result.

7. The sheet recognition unit according to claim 6,
wherein the processing circuitry subtracts the amount of the infrared light from at least one of the output value of the first light receiving element or the output value of the third light receiving element to further calculate at least one of an amount of blue light or an amount of red light as the subtraction result.

8. The sheet recognition unit according to claim 2,
wherein the color filter of the fourth light receiving element transmits only red light, and
wherein the processing circuitry subtracts the output value of the fourth light receiving element from the output value of the third light receiving element to calculate an amount of infrared light as the subtraction result.

9. The sheet recognition unit according to claim 8,
wherein the processing circuitry subtracts the amount of the infrared light from at least one of the output value of the first light receiving element or the output value of the second light receiving element to further calculate at least one of an amount of blue light or an amount of green light as the subtraction result.

10. The sheet recognition unit according to claim 1,
wherein the first light receiving element, the second light receiving element, the third light receiving element, and the fourth light receiving element are arranged in a row in a main scanning direction.

11. The sheet recognition unit according to claim 1,
wherein the first light receiving element, the second light receiving element, and the third light receiving element are arranged in a row along a first reference line parallel to a main-scanning direction, and
wherein the fourth light receiving elements are arranged in a row along a second reference line parallel to the main-scanning direction, the second reference line being at a position shifted from the first reference line to a sub-scanning direction.

12. The sheet recognition unit according to claim 1,
wherein the light having specific wavelength emitted by the light source is ultraviolet light,
wherein the light sensor receives photoluminescence emitted from the sheet to be recognized, the sheet being irradiated with the ultraviolet light, and outputs a photoluminescence detection signal as the light detection signal, and
wherein the processing circuitry recognizes the sheet to be recognized, using the photoluminescence detection signal output from the light sensor.

13. The sheet recognition unit according to claim 12,
wherein the processing circuitry recognizes the sheet to be recognized, based on whether a visible photoluminescence emission amount and an infrared photoluminescence emission amount of the sheet to be recognized are within an allowable range with respect to reference data relating to a visible photoluminescence emission amount and an infrared photoluminescence emission amount in a genuine sheet.

14. The sheet recognition unit according to claim 13,
wherein the reference data includes a ratio between the visible photoluminescence emission amount and the infrared photoluminescence emission amount, and
wherein the processing circuitry calculates the ratio between the visible photoluminescence emission amount and the infrared photoluminescence emission amount of the sheet to be recognized, and recognizes the sheet to be recognized, based on whether the ratio is within an allowable range with respect to the ratio included in the reference data.

15. The sheet recognition unit according to claim 13,
wherein the light sensor receives photoluminescence of at least one color among blue, green, or red as the visible photoluminescence and outputs a photoluminescence detection signal of the at least one color,
wherein the reference data relates to a photoluminescence emission amount of the at least one color and an infrared photoluminescence emission amount, and
wherein the processing circuitry recognizes the sheet to be recognized, based on whether the photoluminescence emission amount of the at least one color and the infrared photoluminescence emission amount of the sheet to be recognized are within an allowable range with respect to the reference data.

16. The sheet recognition unit according to claim 15,
wherein the light sensor receives green photoluminescence as the visible photoluminescence and outputs a green photoluminescence detection signal,
wherein the reference data relates to a green photoluminescence emission amount and an infrared photoluminescence emission amount, and
wherein the processing circuitry recognizes the sheet to be recognized, based on whether the green photoluminescence emission amount and the infrared photoluminescence emission amount of the sheet to be recognized are within an allowable range with respect to the reference data.

17. The sheet recognition unit according to claim 15,
wherein the light sensor receives red photoluminescence as the visible photoluminescence and outputs a red photoluminescence detection signal,
wherein the reference data relates to a red photoluminescence emission amount and an infrared photoluminescence emission amount, and
wherein the processing circuitry recognizes the sheet to be recognized, based on whether the red photoluminescence emission amount and the infrared photoluminescence emission amount of the sheet to be recognized are within an allowable range with respect to the reference data.

18. The sheet recognition unit according to claim 15,
wherein the light sensor receives blue photoluminescence as the visible photoluminescence and outputs a blue photoluminescence detection signal,
wherein the reference data relates to a blue photoluminescence emission amount and an infrared photoluminescence emission amount, and
wherein the processing circuitry recognizes the sheet to be recognized, based on whether the blue photoluminescence emission amount and the infrared photoluminescence emission amount of the sheet to be recognized are within an allowable range with respect to the reference data.

19. The sheet recognition unit according to claim 13,
wherein the light sensor receives near-infrared photoluminescence as the infrared photoluminescence and outputs a near-infrared photoluminescence detection signal,
wherein the reference data relates to a visible photoluminescence emission amount and a near-infrared photoluminescence emission amount, and
wherein the processing circuitry recognizes the sheet to be recognized, based on whether the visible photoluminescence emission amount and the near-infrared photoluminescence emission amount of the sheet to be recognized are within an allowable range with respect to the reference data.

20. A sheet recognition method, comprising:
emitting light having a specific wavelength to a sheet to be recognized from a light source;
receiving, with a light sensor, light coming from the sheet to be recognized, based on the light from the light source and outputting a light detection signal; and
recognizing the sheet to be recognized, using the light detection signal output from the light sensor,
the light sensor including a first light receiving element including a color filter that transmits blue light and infrared light, a second light receiving element including a color filter that transmits green light and infrared light, a third light receiving element including a color filter that transmits red light and infrared light, and a fourth light receiving element including a color filter that transmits only one of blue light, green light, red light, or infrared light.
